(19) United States
(12) Patent Application Publication
(10) Pub. No.: US 2024/0162658 A1
(43) Pub. Date: May 16, 2024

(54) Cord Restraint for Electrical Cords and Medical Tubing Restraint for Medical Tubing

(71) Applicant: Roger Cheston BROACH, Tulsa, OK (US)

(72) Inventor: Roger Cheston BROACH, Tulsa, OK (US)

(21) Appl. No.: 18/417,784

(22) Filed: Jan. 19, 2024

Related U.S. Application Data
(63) Continuation-in-part of application No. 17/328,840, filed on May 24, 2021, now Pat. No. 11,881,654.
Application No. 17/328,840 is a division of application No. 15/812,918, filed on Nov. 14, 2017, now Pat. No. 11,018,453.
(60) Provisional application No. 62/421,421, filed on Nov. 14, 2016.

(51) Int. Cl. H01R 13/639; F16G 1/02; F16G 11/02; F16L 3/123

(52) U.S. Cl. CPC H01R 13/6392; F16G 1/02; F16G 11/02; F16L 3/1236

(57) ABSTRACT

A device and method for holding an electrical cord or medical tubing, such as a cellular phone charging cord or intravenous tube, so that the electrical cord or medical tubing is easily restrained, located and retrieved. The device may be constructed of a flexible body that may be in any desirable shape. The body is provided with a slit that extends some distance, and in some embodiments, approximately halfway through the body. An electrical cord or medical tubing can be inserted through the slit. At the center of the body, the slit is enlarged to form a channel for receiving the electric cord or medical tubing. With the electric cord or medical tubing secured within the channel in the body, the electric cord or medical tubing is easily located and less likely to fall off a surface where the electric cord or medical tubing is placed.

### CROSS-REFERENCE TO RELATED APPLICATIONS

This application is a continuation-in-part application of co-pending divisional U.S. patent application Ser. No. 17/328,840, entitled Cord Restraint for Electrical Cords, filed May 24, 2021, which claims the benefit of U.S. patent application Ser. No. 15/812,918, entitled Cord Restraint for Electrical Cords, filed Nov. 14, 2017, now U.S. Pat. No. 11,018,453, which claims the benefit of U.S. provisional patent application Ser. No. 62/421,421, entitled Cord Restraint for Electric Cords, filed Nov. 14, 2016, the entirety of which are incorporated herein by reference.

### TECHNICAL FIELD OF THE INVENTION

The present invention relates generally to methods and devices for holding an electrical cord, such as a cellular phone charging cord, and more particularly, but not by way of limitation, to cord restraints for electrical cords so that the electrical cord is easily restrained, located and retrieved. The present invention also relates generally to methods and devices for holding medical tubing, such as intravenous tubing and oxygen tubing, and more particularly, but not by way of limitation, to restraints for medical tubing so that the medical tubing is easily restrained, located and retrieved.

### SUMMARY OF THE INVENTION

The present invention is directed to a medical tubing restraint for medical tubing having a diameter, the medical tubing restraint comprising: a flexible foam body having a diameter, wherein the flexible foam body forms a channel having a diameter that is substantially uniform in diameter and that is adapted for circumferentially receiving the medical tubing, the channel formed through the flexible foam body; and wherein the flexible foam body has a longest dimension and the channel is co-extensive with the longest dimension of the flexible foam body; wherein the flexible foam body circumferentially engages the medical tubing in the channel via surface friction; and wherein the ratio of the diameter of the medical tubing restraint to the diameter of the flexible foam body is substantially greater than the diameter of the medical tubing.

The present invention further is directed to a medical tubing restraint for medical tubing having a diameter, the medical tubing restraint comprising: a flexible foam body having a diameter and forming a channel having a diameter that is substantially uniform in diameter and that is adapted for circumferentially receiving the medical tubing; wherein the flexible foam body has a longest dimension and the channel is co-extensive with the longest dimension of the flexible foam body and restrains the medical tubing therein without looping the medical tubing; and wherein the ratio of the diameter of the flexible foam body is substantially greater than the diameter of the medical tubing.

The present invention further is directed to a method of restraining medical tubing having a diameter, the method comprising the steps of: providing a flexible foam body having a diameter and a longest dimension, wherein the diameter of the flexible foam body is substantially greater than the diameter of the medical tubing; providing a channel through the flexible foam body for circumferentially receiving the medical tubing, wherein: the channel has a diameter that is substantially uniform in diameter; and the channel is co-extensive with the longest dimension of the flexible foam body; and circumferentially engaging the medical tubing in the channel via surface friction.

A method of restraining medical tubing having a diameter, the method comprising the steps of: providing a flexible foam body having a diameter and a longest dimension, wherein the diameter of the flexible foam body is substantially greater than the diameter of the medical tubing; providing a channel through the flexible foam body for circumferentially receiving the medical tubing, wherein: the channel has a diameter that is substantially uniform in diameter; and the channel is co-extensive with the longest dimension of the flexible foam body; and circumferentially engaging the electrical cord in the channel without looping the medical tubing.

### BRIEF DESCRIPTION OF THE DRAWINGS

FIG. 1 is a front plan view of an exemplar of the electric cord and medical tubing restraint constructed in accordance with the present invention, depicting an electric cord or medical tubing secured within the channel running therethrough.

FIG. 2 is side view of an exemplar of the electric cord and medical tubing restraint constructed in accordance with the present invention.

FIG. 3 is a cross sectional view of the electric cord and medical tubing restraint of FIG. 2 taken along line 3-3.

### DETAILED DESCRIPTION OF THE INVENTION

Many people have a cellular phone charger near their nightstand or bed so that they can charge their cellular phone. One of the problems with such an arrangement is that the electrical cord of the phone charger is easily dislodged from the charging surface. Additionally, the electrical cord is small and can be hard to locate. To further complicate matters, the cord tends to fall or be dragged onto the floor behind the night stand, bed or between the night stand and the bed. In order to retrieve the cord, one must get on their hands and knees to search for the electrical cord or, in some circumstances, move furniture to retrieve the cord.

An additional problem occurs when using a cellular phone charger in a vehicle. The electrical cord tends to fall or be dragged onto the floor or between the seats. For safety reasons, the driver must bring the vehicle to a stop in order to search for the cord.

The present invention addresses these problems by providing a cord restraint for an electrical cord wherein the cord restraint mitigates the risk that the electrical cord will be dislodged from the charging surface and makes it easier to find the electrical cord when it is dislodged and lost. The present invention also can be used as a flotation device for cords for water-proof devices. As used herein, an electrical cord includes charging, communication, data distribution and power cords, cables, wires, lines, leads and filaments for electrical devices.

In addition, the present invention has applicability in the medical field. Many patients, when hospitalized, experience an intravenous tube, also referred to as an “IV”. The IV is often pulled at the injection site, for example, if the tubing is snagged or tugged when the patient changes positions within the hospital bed. Similar problems can occur with oxygen tubes, monitoring cords and medical tubing in a hospital, nursing home, rehabilitation center, hospice center or other medical and health-related settings. As used herein, medical tubing means tubing that allows the administration or flow of fluid and gases in a medical application to a patient or to or from equipment used in connection with the healthcare of a patient. Common applications of medical tubing include ventilators and IVs, but medical tubing also finds uses in supporting access devices and delivery devices, such as catheters, feeding tubes, nasal cannula, J-tubes, G-tubes, surgical tubing, heart monitoring tubes, anesthesia administration, respiratory equipment, ventilators, peristaltic pumps, biopharmaceutical laboratory equipment and other equipment and devices for monitoring vital signs.

Medical staff have been known to loop a patients' medical tubing and monitoring cords inside the bed enclosure, although these inevitably end up on the floor. Furthermore, looping can lead to constrictions or even kinks in the tubing, which is potentially dangerous for the patient. The present invention is useful to restrain the tubing and monitoring cords within the bed enclosure, without looping, thereby alleviating the problem.

The present invention also is useful in hospital and medical settings to identify the source and contents of the various types of tubing connected to the patient or the patient's bed by the application of color coding. For example, a green restraint may be used to identify the tubing for oxygen, a red restraint to identify the tubing for IV plasma, a blue restraint for IV medications. Additionally, shape coding may be used to restrain, separate and categorize the various medical tubing at a patient's bedside. For example, a tubing restraint shapes like a sphere may be used to identify oxygen tubing and cube may be used to identify IV medication tubing.

The present invention addresses problems related to securing and restraining electrical cords and medical tubing, of which many electrical cords and monitoring cords are utilized in the medical field. The application of the invention to medical tubing used for conveying IV fluids and oxygen to patients in the hospital and color and/or shape coding of the invention. The additional uses of the present invention to address problems encountered within the medical field with respect to medical tubing mitigates clutter and creates efficiencies at the patient's bedside, while having the potential to save lives.

The cord and medical tubing restraint of the present invention comprises a body that may be constructed of a flexible foam material in the form of a ball, cube, or any other desirable shape. For the purpose of this invention, the body is provided with a slit that extends some distance into body and into which the cord can be inserted. Because the body is foam, it can be compressed or separated to allow the cord to be easily inserted into or removed from the slit within the body. At some distance into the body, for example, the center of the body, the slit is enlarged to form a channel for receiving the cord. With the cord thus secured within the channel, the body makes the cord easier to find and less likely to slip or fall off of a nightstand or other surface where the cord is to be placed. These and other advantages of the present invention will be apparent from the following description of embodiments.

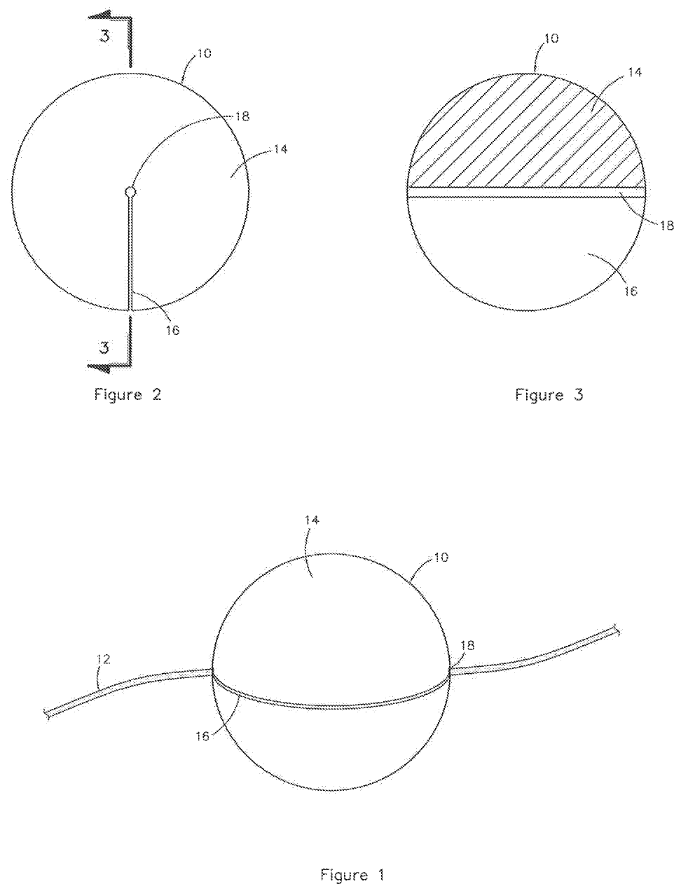

Turning now to the drawings in general, and to FIG. 1 in particular, there is shown therein an exemplar of an electric cord and medical tubing restraint 10 constructed in accordance with the present invention. The electric cord and medical tubing restraint 10 of FIG. 1 is shown with an electric cord or medical tubing 12 secured therein. The electric cord and medical tubing restraint 10 comprises a body 14 that may be in the form of a ball, cube, sphere, torus, polyhedron, sporting equipment, body parts or any other desirable shape. For purposes of illustration only, FIG. 1 depicts a ball shaped structure or spherical body 14.

The body 14 preferably is flexible. To that end, the body 14 may be comprised of any solid foam material that is conformable and deformable to receive an object, yet which engages the surface of the electrical cord or medical tubing 12 when inserted into the body. Some solid foams that are useful in the present invention for constructing the body 14 include ethylene-vinyl acetate (EVA) foam, polyethylene-vinyl acetate (PEVA), low-density polyethylene (LDPE) foam, first grade of polyethylene (PE), nitrile rubber (NBR) foam, the copolymers of acrylonitrile (ACN) and butadiene, polychloroprene foam or neoprene, polyimide foam, polypropylene (PP) foam, including expanded polypropylene (EPP) and polypropylene paper (PPP), polystyrene (PS) foam, including expanded polystyrene (EPS), extruded polystyrene foam (XPS) and sometimes polystyrene paper (PSP), styrofoam, including extruded polystyrene foam (XPS) and sometimes expanded polystyrene (EPS), polyurethane (PU) foam, viscoelastic polyurethane foam, or low-resilience polyurethane foam (LRPu), memory foam, sorbothane, polyvinyl chloride (PVC) foam, closed-cell PVC foamboard, silicone foam and microcellular foam, and combinations of the foregoing. In one embodiment of the invention, the body 14 is comprised of polyurethane foam (PU), which is a type of memory foam commonly used as stress reducers that can be squeezed to reduce stress or tension. For purposes yet to be described, one advantage of polyurethane foam is that it is flexible and soft and deforms easily in response to warmth and pressure. However, it will be appreciated that any foam material capable of receiving the electrical cord 12 may be used to construct the body 14. Certain foam materials provide greater surface friction and gripping engagement with the electrical cord or medical tubing 12, thus enabling the body 14 to be smaller in size and still permit the electrical cord or medical tubing to be easily restrained, located and retrieved.

In medical applications, it is important that the electrical cord and medical tubing restraint 10 be small so as not to clutter the patient's bed or surgical table, particularly where a plurality of medical tubings are in use. The properties of the foam material permit surface friction and gripping engagement with the medical tubing 12 and enables the flexible foam body 14 to be smaller in size and still permit medical tubing 12 to restrained, separated, organized, categorized and retrieved while minimizing clutter.

In medical applications, clinicians may attempt to restrain medical tubing by looping the patients' medical tubing 12 and electrical cords from monitoring equipment inside the bed enclosure, which creates kinks in the medical tubing and potentially endangers the patient. Moreover, the medical tubing 12 inevitably slides off the bed or onto the floor, even when it is looped. The electrical cord and medical tubing restraint 10 is useful to restrain the cords and medical tubing 12 within the bed enclosure, without looping, thereby alleviating the problem. Medical tubing 12 may be made from a variety of materials, such as polyvinyl chloride (PVC), polyethylene (PET), ultra-high molecular weight polyethylene (UHMWPE), polypropylene, polycarbonate, polystyrene, acrylonitrile butadiene styrene (ABS), polyethylene terephthalate glycol (PETG), and polymethyl methacrylate (acrylic). Among other physical and chemical properties, these materials have a generally low coefficient of friction (COF), making them ideal for use in medical applications and for insertion into the human body. However, medical tubing 12 with a low COF has the disadvantage of sliding and falling at the bedside, surgical table or other medical application. The flexible foam body 14 of the electrical cord and medical tubing restraint 10 compensates for the low COF of medical tubing 12. It now will be appreciated that the foam material from which the flexible body 14 is made provides greater surface friction and gripping engagement with the electrical cord or medical tubing 12, thus enabling the body of the electrical cord and medical tubing restraint 10 to be smaller in size and still permit the electrical cord or medical tubing to be easily restrained, located and retrieved. It also will be appreciated that the body 14 may be comprised of any solid foam material that is conformable and deformable to receive an object, yet which engages the surface of the electrical cord or medical tubing 12 when inserted into the flexible foam body 14.

The electrical cord and medical tubing restraint 10 also is useful in hospital and medical settings to identify the source, function, substance and contents of the various types of medical tubing 12 connected to the patient or the patient's bed by the application of color coding. The medical tubing 12 typically supplies a source, function, substance and contents to be administered to a patient or to be removed from a patient. The flexible foam body 14 may be color coded to identify the medical tubing 12 by source, function, substance or contents and to identify, restrain, separate, organize and categorize various medical tubings at the patient's bedside, operating table or other medical application. For example, a green medical tubing restraint 10 may be used to identify the medical tubing for oxygen, a red medical tubing restraint may be used to identify the medical tubing or IV plasma, a blue medical tubing restraint 10 may be used to identify the medical tubing for IV meds, or a yellow medical tubing restraint may be used to identify the medical tubing for catheter. Additionally, shape coding may be used to restrain, separate and categorize the various medical tubing at a patient's bedside. For example, a tubing restraint shapes like a sphere may be used to identify oxygen tubing, and a cube may be used to identify IV medication tubing.

Turning now to FIGS. 2 and 3, the body 14 is provided with a slit 16 for permitting ingress and egress of the electrical cord or medical tubing 12. The electrical cord or medical tubing 12 may be inserted into the channel 18 through the slit 16. The slit 16 extends continuously some distance into the body 14 and communicates with and terminates in a channel 18 in a manner yet to be described. The body 14 may be squeezed or deformed to allow the electrical cord or medical tubing 12 to be easily inserted into or removed through the slit 16 within the body 14.

Turning to FIG. 3, but with continuing reference to FIGS. 1 and 2, it will be appreciated that the slit 16 terminates in and communicates with a channel 18 formed in the body 14 at a sufficient distance into the body 14. The channel 18 holds and securely engages the electrical cord or medical tubing 12. In one embodiment of the invention, the slit 16 extends approximately halfway through the body 14 or to the center of the body. The distance that the slit 16 extends into the body 14 before terminating in channel 18 depends upon location of the channel, the size and shape of the body, the weight and thickness of the electrical cord or medical tubing 12 and the type of foam used to construct the body. Heavier and/or thicker electrical cords or medical tubing 12 will require stronger engagement with the body 14 which may be imparted by selecting a foam that easily restrains and grips the cord, and thus permits the electric cord and medical tubing restraint 10 to be more easily located and retrieved without the electrical cord or medical tubing 12 extending as far into the body. It will be appreciated, however, that the electrical cord or medical tubing 12 generally will be more securely held in place in the electric cord and medical tubing restraint 10 when the electrical cord or medical tubing is received more deeply into the body 14.

The channel 18 is formed a sufficient distance into the body 14 and runs therethrough. In one embodiment of the invention, the channel 18 may be situated approximately halfway through the body 14 or at the center of the body. The distance that channel 18 extends into the body depends upon the size and shape of the body, the weight and thickness of the electrical cord or medical tubing 12 and the type of foam used to construct the body. Heavier and/or thicker electrical cords and medical tubing 12 will require stronger engagement with the body 14 which may be imparted by selecting a foam that easily restrains and grips the cord, and thus permits the electric cord and medical tubing restraint 10 to be more easily located and retrieved without the channel 18 extending as far into the body. It will be appreciated, however, that the electrical cord and medical tubing 12 generally will be more securely held in place in the electric cord and medical tubing restraint 10 when the channel 18 is situated more deeply in the body 14 and the electrical cord or medical tubing, accordingly, is received more deeply into the body 14.

The channel 18 may run through the body 14 vertically, horizontally, diagonally, or in any other configuration. The orientation of the channel 18 within the body 14 depends upon the shape and size of the body and also upon the type of foam used to construct the body and the thickness and weight of the electrical cord or medical tubing 12. The electric cord and medical tubing restraint 10 will have dimensions which are a function of the size and shape of the body 14.

In one embodiment of the invention, the channel 18 is co-extensive with the longest dimension of the body 14. As shown in FIG. 3, wherein the body 14 is depicted as a sphere, the longest dimension of the body is the diameter of the sphere. Accordingly, to optimize gripping engagement of the body 14 with the electrical cord or medical tubing 12, the channel 18 is contiguous with the diameter of the sphere. It will be appreciated that the location of the channel 18 within the body 14 will vary with the size and shape of the body, and other factors.

The electrical cord or medical tubing 12 is fully received within the channel 18 formed within the body 14 so that the body circumferentially engages the electrical cord or medical tubing. The foam material from which the body is made further secures the electrical cord within the body by creating friction therewith. With the electrical cord or medical tubing 12 thus secured within the channel 18, the body 14 makes the electrical cord or medical tubing 12 easier to find and less likely to slip or fall off of a nightstand or other surface where the electrical cord or medical tubing is placed.

While the invention has been described for use in association with a cord for a cellular phone charger, the invention is not so limited and may be used in association with a variety of different types of cords, medical tubing, electrical devices and medical devices. While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

The invention has been described above both generically and with regard to specific embodiments. Although the invention has been set forth in what has been believed to be preferred embodiments, a wide variety of alternatives known to those of skill in the art can be selected with a generic disclosure. Changes may be made in the combination and arrangement of the various parts, elements, steps and procedures described herein without departing from the spirit and scope of the invention as defined in the following claims.

I claim:

1. A medical tubing restraint for medical tubing having a diameter, the medical tubing restraint comprising:
a flexible foam body having a diameter, wherein the flexible foam body forms a channel having a diameter that is substantially uniform in diameter and that is adapted for circumferentially receiving the medical tubing, the channel formed through the flexible foam body; and
wherein the flexible foam body has a longest dimension and the channel is co-extensive with the longest dimension of the flexible foam body;
wherein the flexible foam body circumferentially engages the medical tubing in the channel via surface friction; and
wherein the ratio of the diameter of the medical tubing restraint to the diameter of the flexible foam body is substantially greater than the diameter of the medical tubing.

2. The medical tubing restraint of claim 1 further comprising a slit terminating in and communicating with the channel, wherein the channel is ingressed and egressed through the slit in the flexible foam body.

3. The medical tubing restraint of claim 1 wherein the channel is formed through the center of the flexible foam body.

4. The medical tubing restraint of claim 1 wherein the flexible foam body is constructed of a material selected from the group consisting of ethylene-vinyl acetate (EVA) foam, polyethylene-vinyl acetate (PEVA), low-density polyethylene (LDPE) foam, first grade of polyethylene (PE), nitrile rubber (NBR) foam, the copolymers of acrylonitrile (ACN) and butadiene, polychloroprene foam or neoprene, polyimide foam, polypropylene (PP) foam, including expanded polypropylene (EPP) and polypropylene paper (PPP), polystyrene (PS) foam, including expanded polystyrene (EPS), extruded polystyrene foam (XPS) and sometimes polystyrene paper (PSP), styrofoam, including extruded polystyrene foam (XPS) and sometimes expanded polystyrene (EPS), polyurethane (PU) foam, viscoelastic polyurethane foam, or low-resilience polyurethane foam (LRPu), memory foam, sorbothane, polyvinyl chloride (PVC) foam, closed-cell PVC foamboard, microcellular foam, and combinations of the foregoing.

5. The medical tubing restraint of claim 4 wherein the flexible foam body is constructed from polyurethane foam (PU).

6. The medical tubing restraint of claim 1 wherein the flexible foam body is spherical.

7. The medical tubing restraint of claim 1 wherein:
the flexible foam body has a color;
the medical tubing supplies a source, function, substance or contents to be administered or removed; and
and wherein the flexible foam body is coded by color to identify, restrain, separate, organize, categorize or retrieve the medical tubing by source, function, substance or contents.

8. The medical tubing restraint of claim 1 wherein:
the flexible foam body has a shape;
the medical tubing supplies a source, function, substance or contents to be administered or removed; and
and wherein the flexible foam body is coded by color to identify, restrain, separate, organize, categorize or retrieve the medical tubing by source, function, substance or contents.

9. The medical tubing restraint of claim 1 wherein the medical tubing restraint is a flotation device for medical tubing for waterproof devices.

10. A medical tubing restraint for medical tubing having a diameter, the medical tubing restraint comprising:
a flexible foam body having a diameter and forming a channel having a diameter that is substantially uniform in diameter and that is adapted for circumferentially receiving the medical tubing;
wherein the flexible foam body has a longest dimension and the channel is co-extensive with the longest dimension of the flexible foam body and restrains the medical tubing therein without looping the medical tubing; and
wherein the ratio of the diameter of the flexible foam body is substantially greater than the diameter of the medical tubing.

11. The medical tubing restraint of claim 10 further comprising a slit terminating in and communicating with the channel, wherein the channel is ingressed and egressed through the slit in the flexible foam body.

12. The medical tubing restraint of claim 10 wherein the flexible foam body is constructed of a material selected from the group consisting of ethylene-vinyl acetate (EVA) foam, polyethylene-vinyl acetate (PEVA), low-density polyethylene (LDPE) foam, first grade of polyethylene (PE), nitrile rubber (NBR) foam, the copolymers of acrylonitrile (ACN) and butadiene, polychloroprene foam or neoprene, polyimide foam, polypropylene (PP) foam, including expanded polypropylene (EPP) and polypropylene paper (PPP), polystyrene (PS) foam, including expanded polystyrene (EPS), extruded polystyrene foam (XPS) and sometimes polystyrene paper (PSP), styrofoam, including extruded polystyrene foam (XPS) and sometimes expanded polystyrene (EPS), polyurethane (PU) foam, viscoelastic polyurethane foam, or low-resilience polyurethane foam (LRPu), memory foam, sorbothane, polyvinyl chloride (PVC) foam, closed-cell PVC foamboard, microcellular foam, and combinations of the foregoing.

13. The medical tubing restraint of claim 10 wherein:
the flexible foam body has a color;
the medical tubing supplies a source, function, substance or contents to be administered or removed; and
and wherein the flexible foam body is coded by color to identify, restrain, separate, organize, categorize or retrieve the medical tubing by source, function,
substance or contents.

14. The medical tubing restraint of claim 10 wherein:
the flexible foam body has a shape;
the medical tubing supplies a source, function, substance or contents to be administered or removed; and
and wherein the flexible foam body is coded by shape to identify, restrain, separate, organize, categorize or retrieve the medical tubing by source, function,
substance or contents.

15. The cord restraint of claim 10 wherein the cord restraint is a flotation device for cords for waterproof devices.

16. The medical tubing restraint of claim 10 wherein the body is spherical.

17. A method of restraining medical tubing having a diameter, the method comprising the steps of:
providing a flexible foam body having a diameter and a longest dimension, wherein the diameter of the flexible foam body is substantially greater than the diameter of the medical tubing;
providing a channel through the flexible foam body for circumferentially receiving the medical tubing, wherein:
the channel has a diameter that is substantially uniform in diameter; and
the channel is co-extensive with the longest dimension of the flexible foam body; and
circumferentially engaging the medical tubing in the channel via surface friction.

18. The method of claim 17 further comprising the step of providing a slit in the flexible foam body, the slit terminating in and communicating with the channel.

19. The method of claim 18 further comprising the step of ingressing and egressing the channel through the slit in the flexible foam body.

20. The method of claim 17 wherein the wherein the step of providing the channel through the flexible foam body further comprises forming the channel through the center of the flexible foam body.

21. The method of claim 17 further comprising the step of forming the flexible foam body from a material selected from the group consisting of ethylene-vinyl acetate (EVA) foam, polyethylene-vinyl acetate (PEVA), low-density polyethylene (LDPE) foam, first grade of polyethylene (PE), nitrile rubber (NBR) foam, the copolymers of acrylonitrile (ACN) and butadiene, polychloroprene foam or neoprene, polyimide foam, polypropylene (PP) foam, including expanded polypropylene (EPP) and polypropylene paper (PPP), polystyrene (PS) foam, including expanded polystyrene (EPS), extruded polystyrene foam (XPS) and sometimes polystyrene paper (PSP), styrofoam, including extruded polystyrene foam (XPS) and sometimes expanded polystyrene (EPS), polyurethane (PU) foam, viscoelastic polyurethane foam, or low-resilience polyurethane foam (LRPu), memory foam, sorbothane, polyvinyl chloride (PVC) foam, closed-cell PVC foamboard, microcellular foam, and combinations of the foregoing.

22. The method of claim 17 further comprising the step of securing the medical tubing in the device.

23. The method of claim 10 further comprising the step of using the device as a flotation device in liquid.

24. The method of claim 17 further comprising the steps of color coding the flexible foam body to identify, restrain, separate, organize, categorize or retrieve the medical tubing by source, function, substance or contents.

25. The method of claim 17 further comprising the steps of shape coding the flexible foam body to identify, restrain, separate, organize, categorize or retrieve the medical tubing by source, function, substance or contents.

26. A method of restraining medical tubing having a diameter, the method comprising the steps of:
providing a flexible foam body having a diameter and a longest dimension, wherein the diameter of the flexible foam body is substantially greater than the diameter of the medical tubing;
providing a channel through the flexible foam body for circumferentially receiving the medical tubing, wherein:
the channel has a diameter that is substantially uniform in diameter; and
the channel is co-extensive with the longest dimension of the flexible foam body; and
circumferentially engaging the medical tubing in the channel without looping the medical tubing.

27. The method of claim 26 further comprising the step of providing a slit in the flexible foam body, the slit terminating in and communicating with the channel.

28. The method of claim 27 further comprising the step of ingressing and egressing the channel through the slit in the flexible foam body.

29. The method of claim 26 wherein the wherein the step of providing the channel through the flexible foam body further comprises forming the channel through the center of the flexible foam body.

30. The method of claim 26 further comprising the step of forming the flexible foam body from a material selected from the group consisting of ethylene-vinyl acetate (EVA) foam, polyethylene-vinyl acetate (PEVA), low-density polyethylene (LDPE) foam, first grade of polyethylene (PE), nitrile rubber (NBR) foam, the copolymers of acrylonitrile (ACN) and butadiene, polychloroprene foam or neoprene, polyimide foam, polypropylene (PP) foam, including expanded polypropylene (EPP) and polypropylene paper (PPP), polystyrene (PS) foam, including expanded polystyrene (EPS), extruded polystyrene foam (XPS) and sometimes polystyrene paper (PSP), styrofoam, including extruded polystyrene foam (XPS) and sometimes expanded polystyrene (EPS), polyurethane (PU) foam, viscoelastic polyurethane foam, or low-resilience polyurethane foam (LRPu), memory foam, sorbothane, polyvinyl chloride (PVC) foam, closed-cell PVC foamboard, microcellular foam, and combinations of the foregoing.

31. The method of claim 26 further comprising the step of securing the medical tubing in the device.

32. The method of claim 26 further comprising the step of using the medical tubing restraint as a flotation device in liquid.

33. The method of claim 26 further comprising the steps of color coding the flexible foam body to identify, restrain, separate, organize, categorize or retrieve the medical tubing by source, function, substance or contents.

34. The method of claim 26 further comprising the steps of shape coding the flexible foam body to identify, restrain, separate, organize, categorize or retrieve the medical tubing by source, function, substance or contents.
